(19) United States
(12) Patent Application Publication
(10) Pub. No.: US 2012/0279621 A1
(43) Pub. Date: Nov. 8, 2012

(54) STEEL, STEEL FLAT PRODUCT, STEEL PART AND METHOD FOR PRODUCING A STEEL PART

(75) Inventors: Thomas Gerber, Dortmund (DE); Ilse Heckelmann, Kempen (DE); Thomas Heller, Duisburg (DE); Julia Mura, Dusseldorf (DE); Martin Norden, Essen (DE); Nicolas Vives Diaz, Duisburg (DE)

(73) Assignee: THYSSENKRUPP STEEL EUROPE AG, Duisburg (DE)

(21) Appl. No.: 13/519,916

(22) PCT Filed: Apr. 1, 2011
(86) PCT No.: PCT/EP11/55117

§ 371 Date: Jun. 29, 2012

(30) Foreign Application Priority Data
Apr. 1, 2010 (EP) 10158923.2

(51) Int. Cl. B32B 15/04; C22C 38/04; C22C 38/06; C21D 8/02

(52) U.S. Cl. 148/654; 148/330

(57) ABSTRACT

Disclosed is a steel, a steel flat product, a steel part produced from it by hot forming with subsequent hardening, and a method for producing a steel part. In order to guarantee to a high degree of reliability that a part possesses high strength values and an increased elongation at break, the steel contains (in % wt.) C: 0.15-0.40%, Mn: 1.0-2.0%, Al: 0.2-1.6%, Si: 0-1.4%, total of the contents of Si and Al: 0.25-1.6%, P: 0-0.10%, S: 0-0.03%, Cr: 0-0.5%, Mo: 0-1.0%, N: 0-0.01%, Ni: 0-2.0%, Nb: 0.012-0.04%, Ti 0-0.40%, B: 0.0010-0.0050%, Ca: 0-0.0050%, remainder iron and unavoidable impurities.

The invention relates to a steel, to a steel flat product, to a steel part produced from it and to a method for producing a steel part.

The requirements which the automotive industry has to meet by law have increased in recent years. On the one hand, increased passenger safety is required in the event of a crash and, on the other hand, lightweight construction is an important prerequisite for minimising CO₂ emissions and fuel consumption. At the same time, the demands of the user in terms of comfort have grown which has resulted in the motor vehicle becoming heavier as a result of the proportion of electronic parts increasing in size. In order to meet these conflicting requirements, the automotive industry and the flat steel industry have focused strongly on vehicle lightweight construction in the area of the body structure.

Hot formed, press hardened parts consisting of manganese-boron steels are particularly suitable for crash-relevant motor vehicle parts. A typical example for this steel quality is the MnB steel known under the designation “22MnB5” (material number 1.5528). Applications of press hardened parts produced from MnB steels are, for example, B-columns, B-column reinforcement and bumpers of motor car bodies. Parts with complex geometries and maximum strengths (Rₘ: approx. 1500 MPa; R_{p 0.2}: approx. 1100 MPa) can be produced by combined hot forming and press hardening.

The parts produced in this way are characterised by a predominantly martensitic microstructure. Their high strength basically allows the wall thicknesses to be reduced considerably and therefore also allows the weight of the part to be reduced. However, parts hot press hardened from MnB steels typically only have a low ductility (A₈₀: approx. 5-6%). Therefore, in order to prevent failure in the event of a crash, in practice the sheet thickness of hot press hardened parts is, for safety reasons, generally made considerably greater than would, in fact, be necessary considering its strength.

In order, on the one hand, to exploit the lightweight construction potential of parts made from steels of the type referred to and, on the other hand, to also guarantee the deformability behaviour required in a crash, body parts are manufactured from so-called “tailored blanks”. These are sheet blanks which consist of pre-cut sheets of different steel grades. In this way, a “tailored blank” is, for example, provided for producing a B-column of a motor car body, the area of which assigned to the upper part of the B-column consists of a 22MnB5 steel. Then, in the area of the tailored blank assigned to the base of the B-column a steel grade is provided which also has a higher ductility after hot press hardening. An eligible steel is known under the designation H340LAD (material number 1.0933) for this purpose.

Even though significant savings in weight with, at the same time, optimised performance characteristics of the parts produced from them can be achieved by using tailored blanks, the areas consisting of the more ductile material generally have to have a greater sheet thickness in the critical area of the respective part, so that they can absorb the stresses exerted on the part in normal operation. This, in turn, means that the whole part is correspondingly heavier in weight.

Therefore, there is generally the requirement for parts which are subjected to high stress, such as those in particular used in motor vehicle bodies, to be manufactured from a steel sheet material, in which high strengths are combined with good elongation properties.

To meet this requirement, a first development direction is aimed at optimising the production process. Thus, by controlling the cooling rate, a steel grade can be produced with a martensitic microstructure and improved elongation at break. An example for this procedure is described in EP 1 642 991 B1 and provides a high cooling rate until the martensite stop temperature is reached and subsequently a slower cooling rate. In this way, self-tempered martensite is produced which has an improved elongation at break.

An alternative development direction involves optimising the process for producing a grade with a multi-phase microstructure by means of the so-called “warm forming” process. In this process, the steel flat product to be formed into the respective part is heated to a temperature which is between the A_{c1} temperature and the A_{c3} temperature, in which the steel has a two-phase microstructure. If the part which has been heated in this way is hot press hardened, the finished part after cooling has a lower martensite proportion and higher proportions of more ductile phases, such as ferrite and austenite, compared to conventionally austenitised and hardened parts. At the same time, the parts still have a comparably high strength. Thus, with warm formed parts, tensile strengths Rₘ of 800-1000 MPa are obtained with only slightly reduced elongation at break values (A₈₀ approx. 10-20%) compared to the initial state. Such a procedure is, for example, described in WO 2007/034063 A1.

A comparable concept is pursued by patent application WO 2008/102012, but with particular emphasis on forming a coating which is applied to protect against corrosion. In this prior art, it is only stated that the heating temperature is above the A_{c1} temperature and is to be chosen taking into consideration a possible grain growth and the evaporation of the Zn based coating of the steel flat product from which the part is formed. The respectively processed steel flat product is thereby constituted according to different alloying concepts. Thus, the steel in question can contain (in % wt.) 0.15-0.25% C, 1.0-1.5% Mn, 0.1-0.35% Si, max. 0.8% Cr, in particular 0.1-0.4% Cr, max. 0.1% Al, up to 0.05% Nb, in particular max. 0.03% Nb, up to 0.01% N, 0.01-0.07% Ti, <0.05% P, in particular <0.03% P, <0.03% S, >0.0005 to <0.008% B, in particular at least 0.0015% B, and unavoidable impurities and iron as the remainder, wherein the Ti content must be 3.4 times greater than the N content.

Against the background of the prior art mentioned above, the object of the invention was to create a steel, in which it could be guaranteed to a high degree of reliability that a part produced from it in each case had high strength values and an increased elongation at break. A steel flat product produced using this steel, a steel part produced from it and a method suitable for producing such a steel part were also to be specified.

With regard to the steel, this object was achieved according to the invention by a steel alloyed according to Claim 1.

With regard to the steel flat product, the above mentioned object was achieved according to the invention by forming such a steel flat product according to Claim 6.

With regard to the steel part, the above mentioned object was achieved by forming such a steel part according to Claim 9.

Finally, with regard to the method for producing a steel part, the above mentioned object was achieved according to the invention by the method specified in Claim 13.

Advantageous embodiments of the invention are specified in the dependent claims and, like the subject-matter of the independent claims, are explained below in detail.

The invention proceeds from the perception that by choosing a suitable alloy and setting a suitable microstructure composition a steel can be provided which after austenitisation, hot forming and hardening has a high strength of at least 1000 MPa and an elongation at break A₈₀ which in each case is reliably above 6%. The steel according to the invention to this end contains (in % wt.) 0.15-0.40% C, 1.0-2.0% Mn, 0.2-1.6% Al, up to 1.4% Si, wherein the total of the contents of Si and Al is 0.25-1.6%, up to 0.10% P, 0-0.03% S, up to 0.5% Cr, up to 1.0% Mo, up to 0.01% N, up to 2.0% Ni, 0.012-0.04% Nb, up to 0.40% Ti, 0.0015-0.0050% B and up to 0.0050% Ca and iron and unavoidable impurities as the remainder.

A steel flat product according to the invention correspondingly has at least one area which consists of a steel according to the invention. Thus, a steel flat product according to the invention can be formed as a tailored blank, in which one area is produced from a steel according to the invention, whilst another area is produced from another steel. The area of the tailored blank according to the invention produced from the steel according to the invention then forms a high-strength area on the finished steel part produced from the steel flat product, in which a high strength is combined with a good elongation at break. Of course, it is equally also possible for a steel flat product according to the invention to be manufactured uniformly from the steel according to the invention in the form of a cut blank separated from a steel sheet or steel strip. A steel part manufactured from such a steel flat product according to the invention then has the advantageous combination of high strength and good ductility, obtained by the steel alloying process according to the invention, everywhere.

A steel part according to the invention is correspondingly characterised in that in at least one area it consists of a steel according to the invention and in that its microstructure is composed of martensite, austenite and up to 20% by area of ferrite in the area of the high-strength steel according to the invention.

In the course of a process for producing a steel part according to the invention, to begin with a steel flat product is accordingly provided. This steel flat product is then heated through to a temperature of 780-950° C. The austenite proportion is in this way set at least 80%, so that after hot forming a steel according to the invention can be produced with a microstructure which consists of martensite, austenite and up to 20% by area of ferrite. The holding time required for this is typically 2-10 minutes.

Subsequently, the steel flat product is usually conveyed to a hot forming tool where it is hot formed. In order to prevent the cooling from being too pronounced when it is being conveyed, the conveying time should be limited to 5-12 seconds. The hot forming itself can be carried out as press forming in a way which is known per se.

Following the hot forming, the steel part is cooled rapidly enough for the steel part obtained after cooling to have a microstructure which consists of martensite, austenite and up to 20% by area ferrite. The cooling rates typically required for this purpose are in the region of at least 25° C./s. Here, the hot forming and cooling can be carried out in a single step or in two steps. In single step hot press form hardening, the hot forming and the hardening are carried out together in one go in one tool. In contrast, in the two-step process, cold forming is firstly carried out (up to 100%) and the final hot forming, including creation of the microstructure, is only carried out afterwards.

If the respectively processed steel flat product has been austenitised within the above mentioned temperatures, the part obtained according to the invention has a microstructure which is characterised by a combination of a hard phase (martensite) and at least one more ductile phase (austenite and ferrite) after hot forming and accelerated cooling in the area which consists of a steel according to the invention. Here, the ferrite proportion is limited to 20% by area by the composition of the processed steel specified according to the invention, since an improvement in the elongation values and an increase in energy absorption by means of austenite are preferred. The mechanical-technological properties of parts according to the invention are reliably obtained over the entire temperature range of the austenitisation process carried out according to the invention at 780-950° C., in particular at 850-950° C., by the combination of martensite, austenite and at most 20% by area of ferrite.

The stability of the mechanical-technological properties of the part produced according to the invention is ensured by the analysis concept according to the invention. The microstructure of a part according to the invention, which consists of a combination of hard (martensite) and ductile (austenite and ferrite) phases, guarantees optimum behaviour when the part is stressed in a crash. The phase transformation from austenite to martensite, which occurs when the hot formed part is deformed, causes the part to subsequently increase in hardness when in the event of a crash it is deformed with high kinetic energy.

The combination of high strength, good elongation at break and optimum crash behaviour in its high-strength area aimed for according to the invention is particularly reliably achieved if the martensite content of the microstructure in a part according to the invention is at least 75% by area in the high-strength area concerned. The required high elongation at break can be ensured by the austenite content of the microstructure of the part according to the invention being at least 2% by area.

The tensile strength of a part manufactured from steel according to the invention should not be under 1000 MPa in its high-strength area. The steel alloy according to the invention contains a C content of at least 0.15% wt., so that the martensite hardness required for this purpose can be obtained. At the same time, the C content of the steel according to the invention has an upper limit set at 0.4% wt., so as to ensure sufficient weldability in practice.

With regard to setting the microstructure according to the invention, a special importance is attached to the alloying elements Mn, Si and Al of a steel used according to the invention, since they stabilise the austenite at room temperature.

The Mn, which is present in the steel according to the invention in contents of at least 1.0% wt., serves as an austenite former by lowering the Ac₃ temperature of the steel. The result is a microstructure which after hot forming substantially consists of austenite and martensite.

The Mn content is limited to at most 2% wt. in order, at the same time, to ensure an optimum weldability for the respective application.

Silicon is present in the steel according to the invention in contents of up to 1.4% wt. It affects the hardenability and serves as a deoxidising agent when melting the steel of the part according to the invention. At the same time, Si increases the yield strength, stabilises the ferrite and the austenite at room temperature and prevents unwanted carbide precipitation in the austenite during cooling. An Si content which is too high, however, causes surface defects. Therefore, the Si content of a steel according to the invention is limited to 1.4% wt.

Like Si, aluminium in the steel according to the invention contributes to stabilising the ferrite and the austenite at room temperature and effects control of the grain size. These effects are reliably achieved if the contents of aluminium are limited to 0.2-1.6% wt. in the manner according to the invention, wherein Al contents of at least 0.4% wt. have a particularly positive effect on the properties of a part according to the invention. Carbide formation during the heat treatment is suppressed by an Al content which is above 0.4% wt. and thus the proportion of austenite of preferably at least 2% by area provided according to the invention is stabilised in the hot formed microstructure.

Due to the phase arrangement according to the invention, spreading of the mechanical properties of a steel according to the invention according to its austenitisation, hot forming and cooling can be reduced. Here, it has surprisingly been shown that the mechanical properties of a part produced according to the invention can be obtained with a high degree of reliability over a comparably large range of temperatures to which the steel flat products are heated when they are processed according to the invention. Thus, despite tolerances which inevitably occur in practice when setting the heating temperature referred to, the properties sought after for parts according to the invention can be guaranteed with a highly reliable and stable production result.

Negative effects which Si and Al could have on the condition of the surface are prevented by the total of the Al and Si contents of a steel according to the invention or of a part produced from it being limited to 0.25-1.6% wt. The total of the Al and Si contents of a steel part according to the invention can be raised to at least 0.5% wt., so that at the same time the positive effects of the combined presence of Al and Si are particularly reliably exploited.

Mo can be present in contents of up to 1.0% wt. in a steel according to the invention. The presence of Mo promotes martensite formation and improves the toughness of the steel. An Mo content which is too high can, however, cause cold cracking.

By adding Cr in contents of up to 0.5% wt. to the alloy of a steel according to the invention, the hardenability can be increased. However, the Cr contents should not be higher, so that surface defects are prevented. These effects can be reliably achieved if the Cr content is limited to 0.1% wt.

P can be added by alloying in contents of up to 0.10% wt. to increase the yield strength and hence to secure the mechanical properties. A P content which is too high, however, damages the ductility and the toughness of a steel obtained according to the invention.

Ti in contents of up to 0.40% wt. increases the yield strength, both dissolved and by precipitation formation (e.g. of Ti carbon nitrides). Ti binds N to form TiN and in this way promotes the effectiveness of B in terms of transformation behaviour. This effect can be ensured by the Ti content of the steel according to the invention satisfying the condition

% Ti−(3.42×% N)>0.005% wt.,

wherein % Ti indicates its respective Ti content and % N indicates its respective N content.

The hardenability of a steel according to the invention is improved by 0.00010-0.0050% wt. B by delaying the ferrite transformation during cooling in the direction of longer transformation times. At the same time, the boron present in the steel according to the invention stabilises the mechanical properties for a wide temperature range in the hot forming process.

Up to 0.01% wt. N stabilises the austenite and increases the yield strength of a steel according to the invention. If the nitrogen present in the steel alloyed according to the invention is not fully bound by Ti, it reacts in combination with boron to form boron nitrides. These boron nitrides cause the grain of the original microstructure to be refined and hence cause the martensitic hot formed microstructure to be refined. As a result, the susceptibility of a steel processed according to the invention to cracking is in this way reduced. At the same time, the boron nitrides substantially contribute to increasing the strength of the steel according to the invention.

Should N in combination with B by forming boron nitrides be used to refine the grain and to increase strength, the N content not bound to Ti and required for this purpose can, if

% Ti−(3.42×% N)≦0.005% wt.

applies for its Ti content,
be specifically set by the condition

0.0015≦% N−% Ti/3.42≦0.0060% wt.

being satisfied, wherein % Ti indicates its respective Ti content and % N indicates its respective N content.

The additional addition of Nb in contents of 0.012-0.04% wt. in a steel alloyed according to the invention supports the combination of high tensile strength values with increased elongation at break, which results overall in an increase in the energy absorption capacity of steel parts obtained according to the invention. In steel constituted according to the invention, Nb increases the yield strength by means of carbide precipitation and by means of austenite grain refinement gives rise to a fine martensite microstructure which is highly stable against crack propagation. In addition, Nb precipitations can act as hydrogen traps, whereby the susceptibility to hydrogen-induced cracking can be lowered.

Ni in contents of up to 2.0% wt. contributes to increasing the yield strength and the elongation at break.

The S content of the steel of a part according to the invention is limited to at most 0.03% wt. because S has a highly negative effect on the weldability and the scope for surface finishing. This limitation is also to prevent the formation of damaging, elongated MnS precipitations.

Ca can be added to the steel according to the invention in contents of up to 0.0050% wt. in order to effect control of the sulphide form. Thus, Ca sulphides form in the presence of Ca in the course of rolling, which, in contrast to the elongated MnS precipitations which otherwise potentially form, promote a higher isotropy of the properties of the steel according to the invention.

The steel part according to the invention can be coated on its free surface with a coating protecting against oxidation. This is preferably already present on the steel flat product from which the part is hot formed. The protective coating can be designed so that it protects against scale formation during heating and hot forming and/or against corrosion during processing or in practical use. For this purpose, metallic, organic or inorganic based coatings and combinations of these coatings can be used.

The steel flat product can be coated by means of conventional processes. Surface finishing in the hot-dip coating process is preferred. The optionally applied metallic coatings are based on the systems Zn, Al, Zn—Al, Zn—Mg, Al—Mg, Al—Si and Zn—Al—Mg and their unavoidable impurities. Coatings based on Al—Si have proved particularly successful here.

In order to improve the surface quality and binding of the coating to the steel surface, a pre-oxidation step can be advantageously added upstream from the hot-dip coating process. A 10-1000 nm thick oxide layer is thereby produced in a targeted manner on the steel flat product, wherein particularly good coating qualities are produced if the oxide layer is 70-500 nm thick. The oxide layer thickness is set in an oxidation chamber, as is disclosed, for example, in WO 2007/124781 A1. Before hot-dipping or before surface finishing, the iron oxide layer is reduced by hydrogen of the annealing atmosphere. Oxides of the alloying elements can be present on the surface and up to a depth of 10 μm.

In addition, the steel flat product processed according to the invention can be annealed in a continuous annealing installation or in a batch annealing installation and can be coated by an offline downstream surface finishing installation. Different methods can be used for this purpose.

Electrolytic coating is particularly suitable for applying the respective coating. Particularly good results occur if Zn, ZnFe, ZnMn or ZnNi systems or a combination of these are used as the coating material.

However, it is also possible to apply the coating by PVD (Physical Vapour Deposition) or CVD (Chemical Vapour Deposition) coating processes.

Electroless or chemical deposition of metallic (alloy) coatings based on Zn, Zn—Ni, Zn—Fe and combinations of these, as well as organic/metal-organic/inorganic coatings, can be equally appropriate in coil coating installations in the coil coating, spray or dip coating processes. Typical thicknesses of the coatings, which can be produced using the processes described here, lie in the range from 1-15 μm.

The invention is explained in more detail below by means of exemplary embodiments.

Steel sheets, cold-rolled in the conventional way, were produced from steels E1-E6, the compositions of which are specified in Table 1. A larger number of sheet blanks were separated from each of these steel sheets, which uniformly consisted of the respective steel E1-E6.

For comparison, in corresponding fashion, a steel sheet was produced from comparison steel V, which had a composition which is also specified in Table 1, and a larger number of sheet blanks were separated from this steel sheet which also uniformly consisted of the comparison steel V.

The blanks consisting of the steels E1-E6 and V were in each case heated through in an uncoated condition to a temperature in the range from 880-925° C., subsequently placed in a hot forming tool and then hot formed into a part. After hot forming, the parts respectively hot formed from the blanks were in each case cooled to room temperature at a cooling rate of at least 25° C./s at such a rate that a martensitic structure formed in them. After the actual hot forming conditioning, the samples were additionally subjected to a cathodic dip painting treatment including a baking treatment at 170° C. lasting 20 minutes.

The mechanical properties yield strength R_{p0.2}, tensile strength Rₘ and elongation A₈₀ were determined for the parts obtained. The respectively averaged values R_{p0.2}, Rₘ and A₈₀, as well as the associated standard deviations σR_{p0.2}, σRₘ and σA₈₀, are specified in Table 2 for the steel parts produced from the steels E1-E6 and V. In addition, the product of tensile strength Rₘ and elongation A₈₀ and the result of a 3-point bending test, in which the respective test sample was positioned on two supports spaced apart from one another and was stressed in the middle with an indenter, are recorded in Table 2 for the steel parts consisting of the steels E1-E6 and V. The entries in the column “Energy absorption in the 3-point bending test” in Table 2 refer to the energy absorption up to break. The compositions of the microstructures are also stated in Table 2 for the parts produced from the steels E1, E2 and V.

The parts consisting of the E1-E6 steels according to the invention have proved to have a consistently high residual deformation capacity, characterised by a high value for the product of tensile strength Rₘ and elongation A₈₀, and an accompanying high energy absorption capacity. At the same time, the results of the tests show that the mechanical properties R_{p0.2}, Rₘ and A₈₀ of the parts produced from the E1-E6 steels according to the invention can be reproduced with a considerably higher reliability, characterised by low values of the respective standard deviation, than is the case with the parts produced from the comparison steel V.

TABLE 1
(data in % wt.)

| Steel | C | Si | Mn | P | S | Al | Cr | Mo | N | Ni | Nb | Ti | B | Ca |
|---|---|---|---|---|---|---|---|---|---|---|---|---|---|---|
| E1 | 0.217 | 0.39 | 1.63 | 0.003 | <0.001 | 1.08 | 0.038 | 0.0016 | 0.0011 | 0.014 | 0.025 | 0.036 | 0.0030 | <0.001 |
| E2 | 0.217 | 0.41 | 1.64 | 0.005 | 0.002 | 0.62 | 0.027 | 0.0016 | 0.0023 | 0.008 | 0.029 | 0.022 | 0.0024 | <0.001 |
| E3 | 0.205 | 0.203 | 1.64 | ≦0.10 | ≦0.10 | 0.690 | <0.1 | | 0.0041 | | 0.012 | 0.0010 | 0.0029 | <0.001 |
| E4 | 0.211 | 0.203 | 1.65 | ≦0.10 | ≦0.10 | 0.662 | <0.1 | | 0.0024 | | 0.013 | 0.0020 | 0.0032 | <0.001 |
| E5 | 0.237 | 0.48 | 1.74 | 0.012 | 0.001 | 0.93 | 0.039 | 0.002 | 0.0023 | 0.012 | 0.027 | 0.033 | 0.0026 | 0.0019 |
| E6 | 0.352 | 0.25 | 1.26 | 0.013 | 0.002 | 0.25 | 0.12 | 0.002 | 0.0044 | 0.015 | 0.012 | 0.028 | 0.0026 | 0.0011 |
| V | 0.214 | 0.14 | 1.62 | 0.005 | 0.002 | 1.386 | 0.086 | <0.002 | 0.0015 | 0.006 | 0.006 | 0.0030 | 0.0004 | <0.001 |

TABLE 2

| | | | | | | | | Energy | | | |
|---|---|---|---|---|---|---|---|---|---|---|---|
| | | | | | | | | absorption | | | |
| | | | | | | | Rₘ × A₈₀ | in 3-pt | Ferrite | Austenite | Martensite |
| | R_{p0.2} | σR_{p0.2} | Rₘ | σRₘ | A₈₀ | σA₈₀ | [MPa × | bending | [% by | [% by | [% by |
| Steel | [MPa] | [MPa] | [MPa] | [MPa] | [%] | [%] | %] | test [J] | area] | area] | area] |
| E1 | 966 | 81 | 1467 | 29 | 8.5 | 1.1 | 12470 | 80.4 | 10 | 4 | 86 |
| E2 | 1225 | 12 | 1525 | 5 | 8.1 | 0.4 | 12353 | 83.3 | 0 | 3 | 97 |
| E3 | 1128 | 22 | 1443 | 8 | 6.7 | 0.6 | 10101 | 73 | 0 | 2 | 98 |
| E4 | 1156 | 32 | 1479 | 12 | 6.5 | 0.5 | 10353 | 74 | 0 | 2 | 98 |
| E5 | 1162 | 91 | 1558 | 24 | 7.1 | 0.5 | 11062 | 77.4 | 1 | 3 | 96 |
| E6 | 1393 | 23 | 1864 | 19 | 4.2 | 0.9 | 7829 | 60.8 | 0 | 2 | 98 |
| V1 | 688 | 121 | 1231 | 55 | 9.6 | 2.6 | 11818 | 83.3 | 22 | 3 | 75 |

1. Steel for producing a steel part by hot forming with subsequent hardening, containing (in % wt.)
C: 0.15-0.40%,
Mn: 1.0-2.0%,
Al: 0.2-1.6%,
Si: 0-1.4%,
total of the contents of Si and Al: 0.25-1.6%,
P: 0-0.10%,
S: 0-0.03%,
Cr: 0-0.5%,
Mo: 0-1.0%,
N: 0-0.01%,
Ni: 0-2.0%,
Nb: 0.012-0.04%,
Ti 0-0.40%,
B: 0.0010-0.0050%,
Ca: 0-0.0050%,
remainder iron and unavoidable impurities.

2. The steel according to claim 1, wherein in that the total of its Al and Si contents is at least 0.5% wt.

3. The steel according to claim 1, wherein its Al content is at least 0.4% wt.

4. The steel according to claim 1, wherein in that its Ti content satisfies the condition
% Ti−(3.42×% N)>0.005% wt.,
wherein % Ti indicates its respective Ti content and % N indicates its respective N content.

5. The steel according to claim 1, wherein, if
% Ti−(3.42×% N)≦0.005% wt.
applies for its Ti content,
the condition
0.0015≦% N−% Ti/3.42≦0.0060% wt.
is satisfied, wherein % Ti indicates its respective Ti content and % N indicates its respective N content.

6. A steel flat product for producing a steel part, wherein in that it has at least one area which consists of high-strength steel obtained according to claim 1.

7. The steel flat product according to claim 6, wherein in that it uniformly consists of the high-strength steel.

8. The steel flat product according to claim 6, wherein that at least one of its surfaces is coated with a coating protecting against oxidation.

9. A steel part produced from a steel flat product obtained according to claim 6, wherein its microstructure consists of martensite, austenite and up to 20% by area of ferrite in the area of the high-strength steel obtained according to claim 1.

10. The steel part according to claim 9, wherein in that the martensite content of its microstructure in the area of the high-strength steel is at least 75% by area.

11. The steel Steel part according to claim 9, wherein the austenite content of its microstructure in the area of the high-strength steel is at least 2% by area.

12. The steel part according to claim 9, wherein its surface is coated with a coating protecting against oxidation.

13. A method for producing a steel part obtained according to claim 9, comprising the following production steps:
providing a steel flat product formed according to claim 6,
heating the steel flat product through to a temperature of 780-950° C.,
hot forming the steel flat product into the steel part, and
accelerated cooling of the steel part, so that the steel part obtained after cooling, at least in the area of the high-strength steel, has a microstructure which consists of martensite, austenite and up to 20% by area of ferrite.

14. The method according to claim 13, wherein in that the cooling rate during cooling of the steel part is at least 25° C./s.
